(19) United States
(12) Patent Application Publication
(10) Pub. No.: US 2019/0217654 A1
(43) Pub. Date: Jul. 18, 2019

(54) SELF-ERASING MARKER

(71) Applicant: ERNEST NIZHNER, (US)

(72) Inventor: Ernest Nizhner, Brooklyn, NY (US)

(21) Appl. No.: 16/243,074

(22) Filed: Jan. 8, 2019

Related U.S. Application Data
(60) Provisional application No. 62/617,644, filed on Jan. 16, 2018.

(51) Int. Cl. B43K 5/18; B43K 5/02

(52) U.S. Cl. CPC B43K 5/18; B43K 5/02

(57) ABSTRACT

The subject disclosure relates to systems, methods, and apparatuses that perform self-erasing writings. In an aspect, the subject disclosure includes deploying a self-erasing material, onto a writing medium, from an apparatus comprising a tip element and a body element. In another aspect, the method includes removal of the self-erasing material on a time-released schedule based on an interaction between a set of environmental conditions and the self-erasing material.

### CROSS REFERENCED TO RELATED APPLICATION

This application claims priority to U.S. Patent Application No. 62/617,644 filed on Jan. 16, 2018 and titled “Self-Erasing Device”. The entirety of the disclosure of the aforementioned application is considered part of, and is incorporated by reference in, the disclosure of this application.

### TECHNICAL FIELD

This disclosure generally relates to devices, systems, and methods that perform self-erasing operations using self-erasing materials.

### BACKGROUND

There has long been an unmet need for providing information security measures related to physical written materials as opposed to digital security measures. In many instances, organizations and individuals attempt to protect sensitive information from unintentional disclosures and other such security vulnerabilities, however, most resources are dedicated to securing digital information. However, the same organizations and individuals generate and utilize sensitive and confidential information outside of digital mediums. For instance, many organizations utilize white boards, chalk boards, glass surfaces, or other mediums within conference rooms for memorializing writings and/or illustrations containing sensitive content.

As such, the sensitive content is generated by employing dry erase markers or other traditional tools to write out the sensitive content. After the sensitive information is written, a user is expected to erase the content at a reasonable point in time, such as prior to exiting the room. However, people often leave without erasing boards, walls or surfaces memorializing the content. In several instances, a surface is erased by a new group of users whom enter a conference room during another meeting and such group of new users are left to erase the sensitive content (e.g., trade secrets, personal identifiable information, confidential client information, confidential patient information, etc.) generated by previous users.

The mishandling of such sensitive information can expose organizations or individuals to financial risks, reputational risks, non-compliance risks, transactional risks, political risks, and/or intellectual property theft. Accordingly, confidential information that is recorded, shared, or communicated via a written medium is vulnerable to unauthorized disclosure or theft so long as the information is not erased. Furthermore, even in instances where such content is erased, traces of the writing remain and can be read by unauthorized persons. Also, many mediums including white boards appear dirty, dingy, obfuscated, or aesthetically unpleasing due to remaining traces of writing on the medium. Another limitation associated with writing and current writing mediums are the effort and time required to perform an erasing task of written content. As such, there is a need for technologies that solve the above-mentioned problems associated with written content and writing mediums containing sensitive information.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are systems, devices, apparatuses, and methods that employ components to facilitate self-erasing operations.

According to an embodiment, an apparatus is provided that comprises a tip element capable of deploying a self-erasing material on a writing medium at a first time and self-erases at a second time. In another aspect, the apparatus comprises a body element capable of storing the self-erasing material within at least one cavity, wherein the tip element is connected to the body element, and wherein the tip element is capable of sourcing the material from the at least one cavity.

According to another embodiment, a method is provided. The method can comprise deploying a self-erasing material, onto a writing medium, from an apparatus comprising a tip element and a body element. The method can also comprise removal of the self-erasing material on a time-released schedule based on an interaction between self-erasing material components. In yet another aspect, the method can include the interaction between the self-erasing material components and at least one environmental condition.

### BRIEF DESCRIPTION OF THE DRAWINGS

FIG. 1 illustrates a flow diagram of an example, non-limiting method that facilitates a self-erasing of a written material in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Aspects and advantages of the invention will be set forth in part in the following description, or may be obvious from the description, or may be learned through practice of the invention. Implementations may include one or a combination of any two or more of the aforementioned features. These and other aspects, features, implementations, and advantages, and combinations of them, can be expressed as methods, apparatus's, systems, devices, components, computer program products, computer-implemented methods, computer-implemented systems, business methods, and means or steps for performing functions, or combinations of them. Other features, aspects, implementations, and advantages will become apparent from the description, the drawings, and the claims.

In an aspect, disclosed herein is an apparatus capable of deploying a material such as a writing substance and reactive agent that self-erases within a determined time. As such, the apparatus can be a marker, pen, brush, or other writing tool that contains an ink solution capable of disappearing. For instance, in a non-limiting embodiment, the apparatus can be a marker that allows a user to write on a dry-erase board also referred to as a white board using an ink solution that ceases to appear on the surface of the dry-erase board after a particular period of time. In an aspect, the marker can represent a dependable writing tool and eliminate the need for the user to remove the writing generated by such marker. As a non-limiting example, a group of employees can sketch a flow diagram and illustration of a proprietary technology on a white board located at a conference room in a public location (e.g., library) as part of a group brainstorming exercise. Typically, the employees would need to manually erase the writing on the dry erase board prior to exiting the room.

However, instead of performing a manual erase operation, the users can utilize the marker apparatus or an embodiment thereof that contains ink that begins to vanish from the white board one hour after written on the white board. In a non-limiting instance, the ink can completely vanish from the surface of the white board within five minutes from the commencement of the vanishing. Accordingly, even if the group of employees forget to erase the proprietary illustration and flow diagram content or perform a manual erase operation that still leaves much of the proprietary content visible, the illustration will no longer remain on the white board after 1 hour and 5 minutes from the time it was dispersed on the white board surface. As such, the proprietary information can be automatically removed from the white board and minimize the risk of disclosure of proprietary information to unauthorized parties (e.g., other patrons of the library). Accordingly, the disclosed apparatus facilitates the ability to write on various mediums and the ink can conduct a self-erase operation without a user taking any additional action.

In non-limiting embodiments, the apparatus can employ ink configured to extend or reduce the duration in which it appears on a written medium. For instance, a first version of the marker apparatus can appear on a written medium for a duration of one hour, a second version can appear for two hours, a third version can appear for five hours, a fourth version can appear for ten hours, and/or a fifth version can appear for fifteen hours. As such, in an aspect, the ink can be configured into several formulation variations (e.g., types, levels, concentrations of writing substances and reactive agents, etc.) that allow for the disappearance of the ink to take place within different time periods. Furthermore, the ink formulations can be configured to allow for different variations of erasing to occur. For instance, a first erase type can include the ink to erase from the outer line edges to the inner line edges such that a written line gets thinner (e.g., vanishes towards a central part of the line) until it finally fully vanishes. In another non-limiting embodiment, the ink can uniformly disappear such that the written content will fade out evenly across the entire written content until the ink disappears completely from the surface of a writing medium.

In another aspect, one or more other embodiments of the marker apparatus can comprise ink that can appear for a different range of times such that consumers can utilize an ink that matches its duration needs of the ink. For instance, a user requiring ink to stay permanent for more than a day can use a particular marker configured with a first formulation of ink that allows the ink to disappear after a day has passed from the point of writing the ink. In another instance, a user may require an ink to stay permanent for a short duration (e.g., less than an hour) and as such can utilize a different marker configured with a second formulation of ink that allows the ink to disappear after a shorter duration (e.g., less than an hour) of time has passed from the point of writing the ink.

In another non-limiting embodiment, the range of time can be adjusted by which the ink commences its self-removal or vanishing and the time by which the ink completely vanishes from the writing medium. For instance, in a non-limiting embodiment, the time by which the ink begins to vanish can be 1 hour from the time the ink is deployed onto a writing medium and the time by which it fully vanishes can be 1 hour and five minutes from the time it begins to vanish. In another non-limiting embodiment, the time by which the ink begins to vanish can be 1 hour from the time the ink is deployed onto a writing medium and the time by which it fully vanishes can be 1 hour and thirty minutes from the time it begins to vanish. Accordingly, a user can choose for a shorter or longer vanishing time period to take place based on whether the user would like certain elements of the content to be around longer than other elements of the content. For instance, a user may wish for a graph illustration to remain presented on the white board longer than text written on the white board. As such, the user can utilize a marker with ink that vanishes after a longer period of time for the graph illustration and can utilize a marker with ink the vanishes after a shorter period of time for the written text.

In another aspect, the marker apparatus can contain ink capable of vanishing and represented by various colors (e.g., red, blue, green, orange, yellow, purple, etc.). As such, users can utilize markers configured to write in an assortment of colors that are also configured to self-erase at varying times or the same times on a writing medium depending on a user preference. In another non-limiting embodiment, the self-erasing marker apparatus can comprise a first chamber and a second chamber. In an aspect, the first chamber can include a first solution and the second chamber can include a second solution. In an aspect, the apparatus can allow for the mixing of solutions to create a formulation within the marker that matches a user's preferences. For instance, a user can control the quantity of writing substances and/or reagents mixed from each chamber to generate an ink configured to a particular formulation. As such, a user can create an ink that allows for a longer or shorter period of time until a self-erase operation is performed. Furthermore, in another aspect, within one of the chambers or in a third chamber another element can be included that also allows for a mixing of coloring into the ink as well.

In another, non-limiting embodiment, the marker apparatus can disburse a first writing substance from a chamber of the marker onto a writing medium while writing that allows the ink the to remain until manually erased and the user can release a second writing substance from another chamber as they are writing that transforms the first writing substance into a self-erasing ink. For instance, the chambers can release the writing substance based on a user pressing a release button on the marker apparatus the disperses either first writing substance or second writing substance. Accordingly, a user can use the same marker apparatus to write with ink that requires a manual erase operation and use the same marker apparatus to write with ink that performs a self-erase operation.

In an aspect, the self-erasing marker devices and self-erasing ink formulations disclosed herein can provide solutions for issues regarding non-compliance of policies requiring people to erase walls or boards with written information after use of the wall. Furthermore, this can assist users that forget, are too lazy, unaware of the need, or fail to erase the walls for other such reasons, to accomplish such erasing of important content by using self-erasing markers. Furthermore, in several embodiments, the self-erasing markers and self-erasing ink formulations can keep up aesthetics or good and clean appearances of offices and other spaces comprising writing mediums. For instance, in an embodiment, a white board used for self-erasing markers will not have faded streaks or debris on the board as compared to traditional white boards using conventional marker ink due to the disappearing nature of the self-erasing marker ink. Furthermore, in a non-limiting embodiment, the self-erasing markers can be configured for use in schools and colleges, such that teachers and cleaning staff need not waste time on cleaning writing surfaces used for lectures, but rather can focus on performing teaching and cleaning operations efficiently.

In another non-limiting embodiment, the self-erasing markers can be configured for use in medical procedures. For instance, surgeons can use the self-erase markers to generate guide marks for incisions and/or guidance instructions during surgery. Furthermore, the patient can be free of ink stains on its body due to the self-erasing nature of the marker ink. In another non-limiting embodiment, the self-erasing markers can be used to assist with keeping a home or other domicile clean. For instance, children whom write on walls and other home surfaces for play can use the self-erasing markers such that the children can draw on any surface without ruining the aesthetics of the writing medium due to the self-erasing nature of the marker ink. In yet another non-limiting embodiment, the self-erasing markers can be configured for use in construction applications. For instance, a user can make self-erasing markings on wood, walls, or other surfaces for instructions on drilling locations or cut locations (e.g., via a saw). In yet another embodiment, an erasable marker can be configured for use in celebration applications. For instance, a self-erasing marker can be used to assist with a cleaning process for decorations and celebrations associated with rental party establishments. In another non-limiting embodiment, the apparatus can include self-erasing paint that can disappear after a defined period of time.

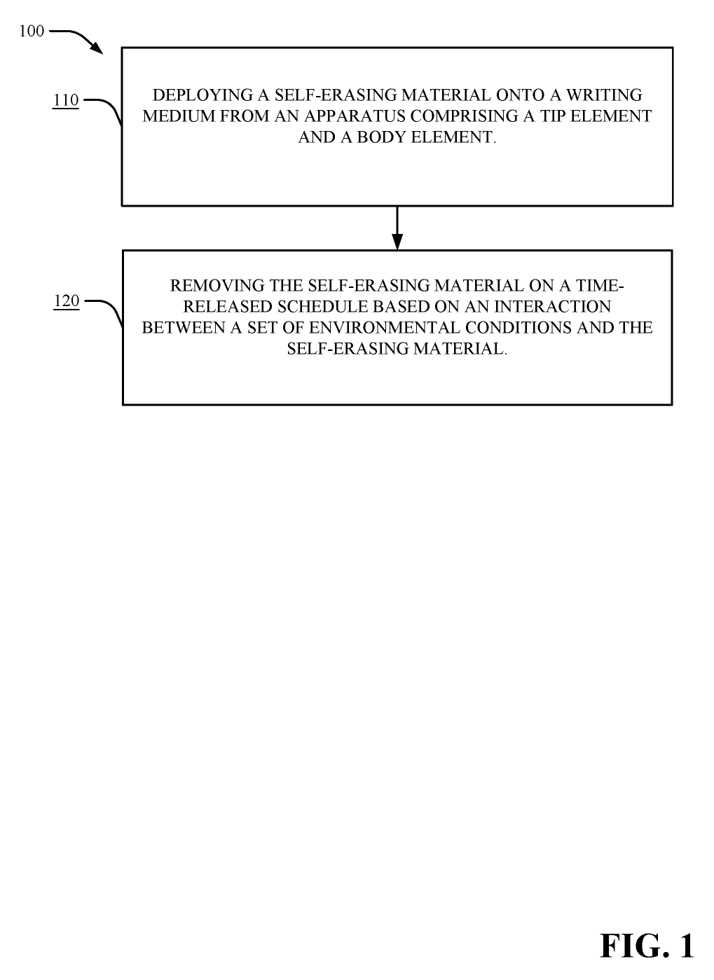

Turning now to FIG. 1 illustrated is a diagram of an example, non-limiting method 100 that facilitates a self-erasing of a written material in accordance with one or more embodiments described herein. In an aspect, at reference numeral 110 a self-erasing material is deployed onto a writing medium, from an apparatus comprising a tip element and a body element. At reference numeral 120, the self-erasing material is removed on a time-released schedule based on an interaction between a set of environmental conditions and the self-erasing material.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus comprising:
a tip element capable of deploying a self-erasing material on a writing medium at a first time and self-erases at a second time; and
a body element capable of storing the self-erasing material within at least one cavity, wherein the tip element is connected to the body element, and wherein the tip element is capable of sourcing the material from the at least one cavity.

2. The apparatus of claim 1, wherein the first time is any of one hour from a starting write time, five hour from the starting write time, ten hour from the starting write time, or fifteen hours from the starting write time, wherein the starting write time is the time that the self-erasing material is applied to a writing medium.

3. The apparatus of claim 1, wherein the self-erasing material is a self-erasing ink comprising at least one writing substance and at least one reactive additive capable of removal.

4. The apparatus of claim 1, wherein the writing medium is at least one of a white board, chalk board, paper, skin, fabric, glass surface, ceramic surface, porcelain surface, painted surface, or other such writing medium.

5. A method comprising:
deploying a self-erasing material, onto a writing medium, from an apparatus comprising a tip element and a body element; and
removal of the self-erasing material on a time-released schedule based on an interaction between self-erasing material components.

6. The method of claim 5, wherein the interaction is between the self-erasing material components and at least one environmental condition.
